(19) United States
(12) Patent Application Publication
(10) Pub. No.: US 2026/0003781 A1
(43) Pub. Date: Jan. 1, 2026

(54) DATA STORAGE DEVICE AND METHOD OF OPERATING THE SAME

(71) Applicant: SK hynix Inc., Icheon-si (KR)

(72) Inventor: Youn Won PARK, Icheon-si (KR)

(21) Appl. No.: 19/196,575

(22) Filed: May 1, 2025

(30) Foreign Application Priority Data
Jul. 1, 2024 (KR) 10-2024-0086259

(51) Int. Cl. G06F 12/02; G06F 12/0891

(52) U.S. Cl. CPC G06F 12/0246; G06F 12/0891; G06F 2212/7201

(57) ABSTRACT

Provided herein may be a data storage device and a method of operating the same. A data storage device for dynamically managing a map update cycle may include a memory device configured to store data, and a controller configured to adjust a cycle at which map data corresponding to write requests received from a host for a preset reference time is stored in the memory device, depending on a number of small data chunk write requests that are write requests for data having a preset unit size, among the write requests.

### PRIORITY CLAIM AND CROSS-REFERENCE TO RELATED APPLICATION

This patent document claims priority under 35 U.S.C. § 119 (a) to Korean patent application number 10-2024-0086259, filed on Jul. 1, 2024, in the Korean Intellectual Property Office, the entire disclosure of which is incorporated by reference herein.

### TECHNICAL FIELD

Various embodiments of the present disclosure generally relate to a data storage device and a method of operating the data storage device, and more particularly to a data storage device for dynamically managing a map update cycle and a method of operating the data storage device.

### BACKGROUND

Data storage devices refer to electronic components that are configured to store data based on a control of a host device, such as a computer or a smartphone. The data storage device may include a memory device in which data is stored and a memory controller which controls the memory device. Memory devices are classified into a volatile memory device and a nonvolatile memory device.

A volatile memory device may store data only when power is supplied. Thus, such a volatile memory device loses its data in the absence of power. Examples of the volatile memory device may include a static random access memory (SRAM) or a dynamic random access memory (DRAM).

A nonvolatile memory device is a memory device that can retain its data in the absence of power. Examples of the nonvolatile memory device include a read only memory (ROM), a programmable ROM (PROM), an electrically programmable ROM

(EPROM), an electrically erasable and programmable ROM (EEPROM), or a flash memory.

### SUMMARY

Various embodiments of the present disclosure are directed to a data storage device for dynamically managing a map update cycle and a method of operating the data storage device.

An embodiment of the present disclosure may provide a controller for controlling a memory device. The controller may include a write data buffer configured to temporarily store write data that is provided from a host, a write map cache configured to store a map entry including a logical address corresponding to the write data and a physical address that corresponds to the logical address and indicates a location at which the write data is to be stored in the memory device, and a map data manager configured to store, in the memory device, the map entry that has been stored in the write map cache in response to an accumulated size of the write data accumulated in the write data buffer reaches a reference size, generate write trend information indicating a number of small data chunk write requests among write requests corresponding to the write data received from the host until the accumulated size of the write data reaches the reference size, the small data chunk write requests including write requests for data having a preset unit size, and adjust the reference size based on the write trend information.

An embodiment of the present disclosure may provide for a controller. The controller may include a host interface configured to receive a write request and write data from a host, a volatile memory device including a write data buffer configured to temporarily store the write data and a write map cache configured to store a map entry including a logical address corresponding to the write data and a physical address indicating a location at which the write data is to be stored to correspond to the logical address, a memory interface configured to communicate with a memory device, and a processor configured to control the host interface, the volatile memory device, and the memory interface. The processor may be configured to control the memory interface to store the map entry stored in the write map cache in the memory device in response to an accumulated size of the write data received from the host reaches a reference size, to generate write trend information indicating a number of small data chunk write requests that correspond to write requests for data having a preset unit size, among write requests that have been received from the host until the accumulated size of the write data reaches the reference size, and to adjust the reference size based on the write trend information.

An embodiment of the present disclosure may provide for a data storage device. The data storage device may include a memory device configured to store data, and a controller configured to adjust a cycle at which map data corresponding to write requests received from a host for a preset reference time is stored in the memory device, based on a number of small data chunk write requests to write data having a preset unit size.

### BRIEF DESCRIPTION OF THE DRAWINGS

FIG. 1 is a diagram illustrating an example of a data storage device including a memory device based on some implementations of the disclosed technology.

FIG. 2 is a diagram illustrating an example of a method in which a controller processes a write request based on some implementations of the disclosed technology.

FIG. 3 is a diagram illustrating an example of a process in which map data stored in a write map cache is stored in a memory device based on some implementations of the disclosed technology.

FIG. 4 is an example of a diagram illustrating the configuration of a controller of FIG. 1 based on some implementations of the disclosed technology.

FIG. 5 is a diagram illustrating an embodiment of write trend information of FIG. 4 based on some implementations of the disclosed technology.

FIG. 6 is a diagram illustrating an embodiment of map update interval information of FIG. 4 based on some implementations of the disclosed technology.

FIG. 7 is an example of a diagram for explaining information included in a write request based on some implementations of the disclosed technology.

FIG. 8 is an example of a diagram for explaining the difference between map update methods depending on whether a write request is an overwrite request based on some implementations of the disclosed technology.

FIG. 9 is a diagram illustrating an embodiment of map update interval information based on some implementations of the disclosed technology.

FIG. 10 is an example of a flowchart illustrating an operation of a data storage device according to an embodiment of the present disclosure.

FIG. 11 is a diagram illustrating an embodiment of the controller of FIG. 1 based on some implementations of the disclosed technology.

FIG. 12 is an example of a block diagram illustrating a user system to which a data storage device according to an embodiment of the present disclosure is applied.

### DETAILED DESCRIPTION

Specific structural or functional descriptions in the embodiments of the present disclosure introduced in this specification or application are provided as examples to describe embodiments according to the concept of the present disclosure. Various embodiments of the present disclosure may be practiced in various forms, and should not be construed as being limited to the embodiments described in the specification or application.

Hereinafter, various embodiments of the present disclosure will be described in detail with reference to the accompanying drawings in which embodiments of the present disclosure are shown so that those skilled in the art to which the present disclosure pertains can easily practice the technical spirit of the present disclosure.

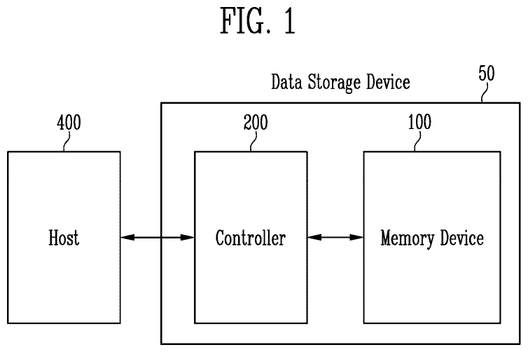

FIG. 1 is a diagram illustrating a data storage device including a memory device.

Referring to FIG. 1, a data storage device 50 may include a memory device 100 and a controller 200. The data storage device 50 may be a device which stores data under the control of a host 400, such as a mobile phone, a smartphone, a laptop computer, a desktop computer, a game console, a smart television (TV), a tablet PC, or an in-vehicle infotainment system. In an embodiment, the data storage device 50 may be a device such as a server or a data center, controlled by the host 400, through wired/wireless communication for storing data at a remote place.

The data storage device 50 may interface with the host 400 through various communication methods, and may be implemented as various devices depending on the interfacing methods. For example, the data storage device 50 may be implemented as any one of various types of storage devices, such as a solid state drive (SSD), an embedded multimedia card (eMMC), a SD, mini-SD, or micro-SD-type secure digital card, a universal serial bus (USB) storage device, a universal flash storage (UFS) device, a personal computer memory card international association (PCMCIA) card-type storage device, a peripheral component interconnection (PCI) card-type storage device, a PCI express (PCI-E) card-type storage device, a compact flash (CF) card, and/or a smart media card.

In an embodiment, the data storage device 50 may be manufactured in any one of various types of package forms. For example, the data storage device 50 may be manufactured in any one of various types of package forms, such as package on package (POP), system in package (SIP), system on chip (SOC), multi-chip package (MCP), chip on board (COB), wafer-level fabricated package (WFP), and/or wafer-level stack package (WSP).

The memory device 100 may store data. The memory device 100 may be operated in response to the control of the controller 200. The memory device 100 may include a plurality of memory cells which store data. Each of the memory cells may store one data bit or a plurality of data bits.

The memory cells may be accessed in units of a preset size depending on the type of memory device. The units in which the memory cells are accessed may differ for respective operations. For example, the memory cells may be accessed in different size units for a write operation (program operation) of storing data in each memory cell, a read operation of sensing data stored in each memory cell, and an erase operation of erasing data stored in each memory cell.

In an embodiment, the memory device 100 may be or include a double data rate synchronous dynamic random access memory (DDR SDRAM), a low power double data rate fourth generation (LPDDR4) SDRAM, a graphics double data rate (GDDR) SDRAM, a low power DDR (LPDDR) SDRAM, a Rambus DRAM (RDRAM), a NAND flash memory, a vertical NAND flash memory, a NOR flash memory, a resistive RAM (RRAM), a phase-change memory (PCM), a magnetoresistive RAM (MRAM), a ferroelectric RAM (FRAM), or a spin transfer torque RAM (STT-RAM).

The memory device 100 may receive a command and an address from the controller 200, and may access the area of the memory cell array, selected by the address. The memory device 100 may perform an operation indicated by the command on the area selected by the address. For example, the memory device 100 may perform a write operation (program operation), a read operation, and an erase operation. During a program operation, the memory device 100 may write data to the area selected by the address. During a read operation, the memory device 100 may sense data from the area selected by the address. During an erase operation, the memory device 100 may erase data stored in the area selected by the address.

The controller 200 may control the overall operation of the data storage device 50.

When power is applied to the data storage device 50, the controller 200 may run firmware (FW). The data storage device 50 may translate a logical address provided by the host 400 into a physical address used by the memory device 100. In the present specification, both a logical address and a logical block address may be addresses for identifying data provided by the host 400, and both a physical address and a physical block address may be used to indicate the location at which data is stored in the memory device 100.

The controller 200 may control the memory device 100 to perform a write operation, a read operation or an erase operation in response to a request received from the host 400. During the write operation, the controller 200 may provide a write command (program command), an address, and data to the memory device 100.

During the read operation, the controller 200 may provide a read command and an address to the memory device 100. During the erase operation, the controller 200 may provide an erase command and an address to the memory device 100.

During the write operation, the controller 200 may receive a write request and write data from the host 400. The write request may include the logical address of write data. In an embodiment, the write request may include an overwrite flag indicating whether the write data is updated data of pre-stored data. In an embodiment, the write data may be provided from the host 400 to the controller 200, with the write data being included in the write request.

When a write request and write data are received from the host 400, the controller 200 may temporarily store the write data in a write data buffer (not illustrated), may allocate a physical address indicating the location at which the write data is to be stored to the logical address of the write data, and may temporarily store a map entry including the physical address and the logical address in a write map cache (not illustrated).

Thereafter, the controller 200 may store, in the memory device, the write data which is stored in the write data buffer. When the write data buffer is full, the controller 200 may perform a write data flush operation of emptying the write data stored in the write data buffer. In an embodiment, when the write data stored in the write data buffer reaches a preset size, that is, when an amount of write data corresponding to the preset size is stored in the write data buffer, the controller 200 may control the memory device 100 to store the write data in the memory device 100. In an embodiment, the controller 200 may adjust the preset size by which the cycle at which the write data flush operation is performed is determined.

The controller 200 may perform a write map cache flush operation that stores, in the memory device 100, map entries which have been stored in the write map cache 220. When the size of the write data stored in the write data buffer reaches a preset reference size, the controller 200 may control the memory device 100 to store the map entries, which have been stored in the write map cache 220 up to that time, in the memory device 100.

In an embodiment, the controller 200 may adjust the reference size by which the cycle at which the write map cache flush operation is performed is determined.

The write requests provided by the host 400 may be classified into small data chunk write requests and large data chunk write requests. Each of the small data chunk write requests may be a write request for write data having a preset unit size. Here, although the preset unit size may be 4 KB, the unit size for determining whether the corresponding write request is a small data chunk write request is not limited to 4 KB, and the unit size may be set differently depending on the type of the data storage device 50.

The controller 200 may adjust the reference size by which the cycle at which the write map cache flush operation is performed is determined, based on the ratio of small data chunk write requests to write requests received until the size of the write data stored in the write data buffer reaches the preset reference size, or the number of small data chunk write requests.

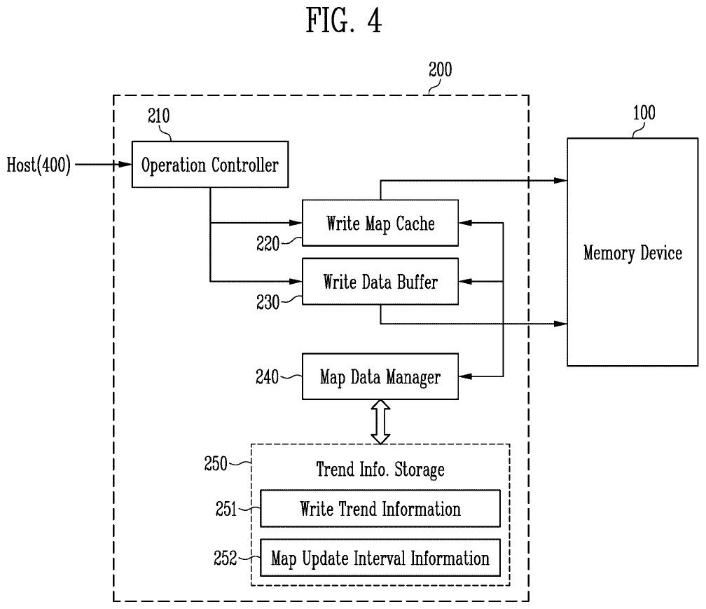

A method in which the controller 200 adjusts the reference size based on the number of small data chunk write requests will be described in detail later with reference to FIGS. 4 to 6.

In an embodiment, the controller 200 may include an error correction code (ECC) processor (not illustrated). In some implementations, the ECC processor may be included in the data storage device 50 as a chip or a device separated from the controller 200. The ECC processor (not illustrated) may detect and correct errors contained in data obtained from the memory device 100 through a read operation. In an embodiment, the number of bits that can be corrected by the ECC processor may be limited.

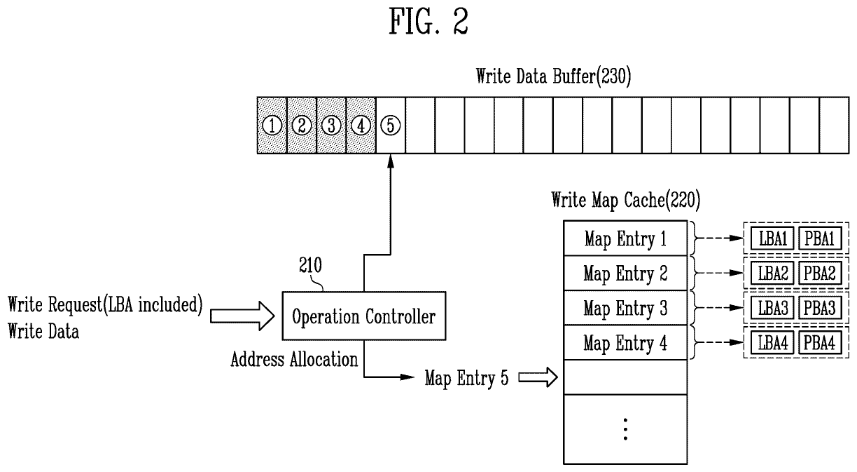

FIG. 2 is an example of a diagram illustrating a method in which a controller processes a write request based on some implementations of the disclosed technology.

Referring to FIG. 2, an operation controller 210 included in the controller 200 may receive a write request and write data from the host 400, as described above with reference to FIG. 1.

The operation controller 210 may store the received write data in a write data buffer 230 and the received write data includes a logical address.

The operation controller 210 may allocate a physical address corresponding to the logical address included in the received write request. The logical address included in the write request may allow the host 400 to identify the write data. The physical address may indicate the location at which the write data is stored in the memory device 100.

In response to receiving the write request including the logical address, the operation controller 210 may allocate a physical address at which the write data is to be stored. The operation controller 210 may generate a map entry including the logical address and the allocated physical address and store the generated map entry in a write map cache 220.

FIG. 2 shows a method of processing a fifth write request and fifth write data by the operation controller 210. In the example, the fifth write request and the fifth write data are input after four write requests and corresponding write data to respective write requests are processed.

In the implementations, data 1 to 4) corresponding to the first to fourth write requests are stored in the write data buffer 230, and first to fourth map entries, Map Entry 1 to Map Entry 4, corresponding to the first to fourth write requests are stored in the write map cache 220.

The operation controller 210 may receive the fifth write request and the fifth write data, and may store the fifth write data 5) in the write data buffer 230. In response to receiving the fifth write request including the logical address, the operation controller 210 may allocate a physical address at which the fifth write data 5 is to be stored, may generate a fifth map entry, Map Entry 5, including the logical and physical addresses, and may store the fifth map entry in the write map cache 220.

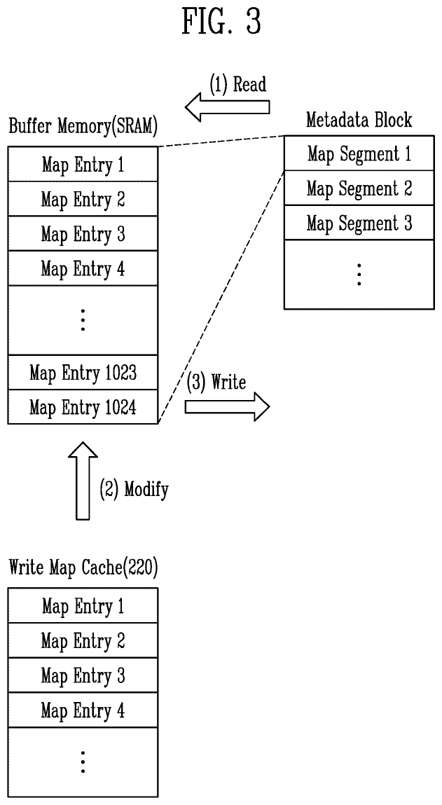

FIG. 3 is a diagram illustrating an example of a process of storing map data in a memory device. The map data refers to data stored in the write map cache as described with reference to FIG. 2.

Referring to FIGS. 1 and 3, the write map cache 220 may include map entries, each including the logical address and the physical address of data requested to be written.

A metadata block may be a memory block, in which map data is stored, among a plurality of memory blocks included in the memory device 100. The metadata block may store map data of the data stored in the memory device 100.

The map data of the memory device 100 may include a plurality of map segments. Each of the plurality of map segments may include a plurality of map entries.

In the following description, one map segment is assumed to include 1024 map entries. That is, a first map segment, Map Segment 1, may include first to 1024-th map entries, Map Entry 1 to Map Entry 1024. A second map segment, Map Segment 2, may include 1025-th to 2048-th map entries.

In order to perform a write map cache flush operation, the controller 200 needs to read a map segment, to which map entries stored in the write map cache 220 belong, into the buffer memory (Read (1)), modify the map entries included in the read map segment to map entries stored in the write map cache 220 (Modify (2)), and store the map segment including the modified map entries back in the metadata block included in the memory device 100 (Write (3)).

When the map entries stored in the write map cache 220 belong to the same map segment, the number of map segments required to be read to perform the write map cache flush operation is 1. When the map entries belong to different map segments, for example, N map segments, N being a natural number greater than 1, N map segments need to be read, modified, and stored to perform the write map cache flush operation.

Therefore, in order to perform the map cache flush operation of storing map data stored in the write map cache 220 in the memory device 100, a lot of time and resources may be required. This may result in a decrease in the write performance of the data storage device 50 itself.

Various implementations of the disclosed technology suggest dynamically adjusting the amount of map data to be updated based on the trend of write requests, which enables the efficient operation of the write map cache.

FIG. 4 is an example of a diagram illustrating the configuration of the controller of FIG. 1.

Referring to FIG. 4, the controller 200 may include an operation controller 210, a write map cache 220, a write data buffer 230, a map data manager 240, and a trend information storage 250.

The operation controller 210 may control the overall operation of the data storage device 50. The operation controller 210 may store data in the memory device 100 or read data stored in the memory device 100 in response to a request from the host 400.

The operation controller 210 may receive a write request and write data from the host 400. The write request received from the host 400 may include the logical address of the write data.

The write request may correspond to either a small data chunk write request or a large data chunk write request. The small data chunk write request may be a write request for write data having a size that is equal to or less than a preset unit size. Here, although the preset unit size may be 4 KB as the example, the unit size for determining whether the write request is the small data chunk write request or not is not limited to 4 KB. Thus, in some implementations, the unit size for determining whether the write request is the small data chunk write request or not may be set differently depending on the type of the data storage device 50. In the example, the large data chunk write request may be a write request for write data exceeding the preset unit size.

The operation controller 210 may allocate a physical address corresponding to the logical address of the write data. The physical address may be an address indicating the location at which the write data is to be stored in the memory device 100. The operation controller 210 may generate a map entry including the logical address of the write data and the allocated physical address and store the generated map entry in the write map cache 220.

The operation controller 210 may store the write data in the write data buffer 230.

The operation controller 210 may control the write data buffer 230 and the memory device 100 to perform a write data flush operation of storing the write data, which has been stored in the write data buffer 230, in the memory device 100. In some implementations, the operation controller 210 may perform the write data flush operation whenever the amount of write data, which is stored in the write data buffer 230, reaches to a preset size. For example, whenever the write data corresponding to the preset size is accumulated in the write data buffer 230, the write data may be stored in the memory device 100. In an embodiment, the operation controller 210 may adjust the preset size to adjust and/or improve the performance of the data storage device.

In some implementations, the write map cache 220 and the write data buffer 230 may be included in a volatile memory device. In an embodiment, the volatile memory device may be a dynamic random access memory (DRAM) or a static random access memory (SRAM).

The map data manager 240 may manage map data stored in the write map cache 220. The map data manager 240 may control the write map cache 220 and the memory device 100 to store map entries, which has been stored in the write map cache 220, in the memory device 100. When the size of write data accumulated in the write data buffer 230 reaches a reference size, the map data manager 240 may perform a write map cache flush operation of storing map entries, which has been stored in the write map cache 220 up to that time, in the memory device 100. Because the write map cache flush operation is an operation of storing, in the memory device 100, map entries which correspond to the map data, it may also be referred to as a map update operation.

The trend information storage 250 may store write trend information 251 and map update interval information 252. The trend information storage 250 may be included in the volatile memory device together with the write map cache 220 and the write data buffer 230.

In an embodiment, the map data manager 240 may generate the write trend information 251. The write trend information 251 may include the number of write requests that have been inputted until the size of the write data accumulated in the write data buffer 230 reaches the reference size, and the number of small data chunk write requests included in the write requests.

The map data manager 240 may count the write requests that have been input until the size of the write data accumulated in the write data buffer 230 reaches the reference size. The map data manager 240 may count the small data chunk write requests among the write requests that have been input until the size of the write data accumulated in the write data buffer 230 reaches the reference size. The map data manager 240 may generate the write trend information 251 including the number of write requests that have been input until the size of the write data accumulated in the write data buffer 230 reaches the reference size, and the number of small data chunk write requests among the write requests, and may store the generated write trend information 251 in the trend information storage 250.

The map data manager 240 may adjust the reference size based on the generated write trend information 251 when the size of the write data accumulated in the write data buffer 230 reaches the reference size. For this, the map data interval information may include information about the reference size depending on the number of small data chunk write requests that have been input until the size of the write data accumulated in the write data buffer 230 reaches the reference size.

The map data manager 240 may adjust the reference size based on the write trend information, and may then initialize the accumulated size of the write data. Thus, the map data manager 240 may count the number of small data chunk write requests whenever the accumulated size of the write data reaches the reference size, and may readjust the reference size depending on the number of small data chunk write requests.

In an embodiment, when the number of small data chunk write requests, which have been input until the size of the write data accumulated in the write data buffer 230 reaches the reference size, increases, since the time required for map update will be lengthened, the map data manager 240 may shorten the time required for map update by reducing the reference size. In some implementations, when the number of small data chunk write requests, which have been input until the size of the write data accumulated in the write data buffer 230 reaches the reference size, decreases, since the time required for map update will be relatively shortened, the map data manager 240 may control the time required for the write map cache flush operation depending on the write trend information by increasing the reference size. The map data manger 24 may adjust the cycle at which the write map cache flush operation is performed depending on the write trend information by dynamically adjusting the reference size. In various embodiments, each write request received from the host 400 may include an overwrite flag indicating whether the write request is an overwrite request indicative of the update for a pre-stored logical address.

When the write request is the overwrite request, an invalidation processing may be also performed on old map data that corresponds to a previously stored logical address. Because the write request includes the overwrite flag, based on the overwrite flag, the map data manager 240 may selectively perform the invalidation processing on the old map data when performing a write map cache flush operation.

In an embodiment, when the number of small data chunk write requests that have been input until the size of the write data accumulated in the write data buffer 230 reaches the reference size is decreased, and then the reference size is increased, the time required for the write map cache flush operation may be lengthened. By utilizing this process, the operation controller 210 may determine the number of data bits to be stored in each memory cell included in the memory device 100 when the write data stored in the write data buffer 230 is stored in the memory device 100. In the implementations, each memory cell included in the memory device 100 may be programmed as a single-level cell (SLC) in which 1 bit of data is stored, a multi-level cell (MLC) in which 2 bits of data are stored, a triple-level cell (TLC) in which 3 bits of data are stored, and/or a quad-level cell (QLC) in which 4 bits of data are stored. The operation controller 210 may increase the number of bits to be stored per memory cell in which write data is stored, as the reference size adjusted by the map data manager 240 increases. For example, when the reference size exceeds a threshold size, the operation controller 210 may control the memory device 100 to store the write data in the memory device 100 in a TLC manner.

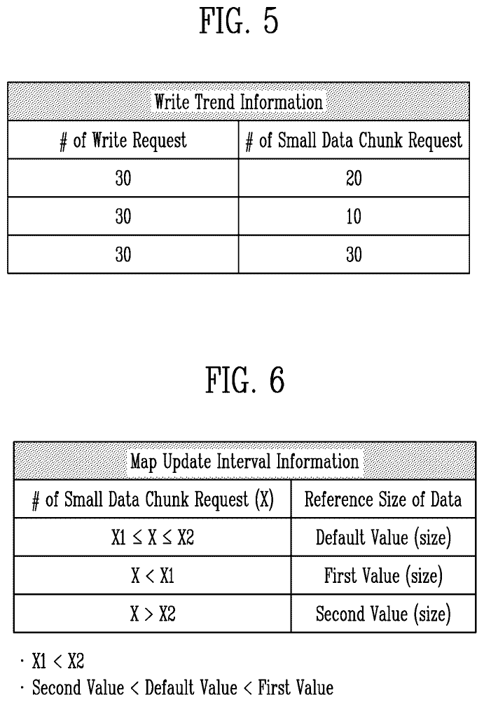

FIG. 5 is a diagram illustrating an embodiment of the write trend information of FIG. 4 based on some implementations of the disclosed technology.

Referring to FIG. 5, the write trend information may include the number of write requests and the number of small data chunk write requests included in the write requests.

In the implementations, the write trend information may include the number of write requests received from the host until the accumulated size of the write data reaches a reference size, and the number of small data chunk write requests among the write requests.

As illustrated in FIG. 5, assuming that the number of write requests, which have been received from the host until the accumulated size of the write data reaches the reference size, is 30, the write trend information may be treated differently in the cases having different numbers of small data chunk write requests. In the example as shown in FIG. 5, three cases that the number of small data chunk write requests are 10, 20, and 30, respectively, are shown and the write trend information may be treated differently in those three cases depending on whether the number of small data chunk write requests among the write requests is 20, 10, or 30.

For example, when the number of small data chunk write requests is 20, a write map cache flush operation may be performed based on the reference size having a default value. When there are 10 small data chunk write requests among the 30 write requests, the map data manager 240 may perform the write map cache flush operation based on the reference size having a value greater than the default value. When there are 30 small data chunk write requests among the 30 write requests, the map data manager 240 may perform the write map cache flush operation based on the reference size having a value less than the default value.

FIG. 6 is a diagram illustrating an embodiment of the map update interval information of FIG. 4 based on some implementations of the disclosed technology.

Referring to FIG. 6, map update interval information may include information about a reference size based on the number of small data chunk write requests included in write requests that have been received from the host until the accumulated size of the write data reaches the reference size.

In FIG. 6, the map data manager 240, which is described with reference to FIG. 4, may perform a write map cache flush operation based on the reference size having the default value when the number of small data chunk write requests included in the write requests received from the host until the accumulated size of the write data reaches the reference size is equal to or greater than X1 and less than or equal to X2 (where X2 is greater than X1).

In an embodiment, the map data manager 240 may perform the write map cache flush operation based on the reference size having a first value greater than the default value when the number of small data chunk write requests included in the write requests that have been received from the host until the accumulated size of the write data reaches the reference size is less than X1.

In an embodiment, the map data manager 240 may perform the write map cache flush operation based on the reference size having a second value less than the default value when the number of small data chunk write requests included in the write requests that have been received from the host until the accumulated size of the write data reaches the reference size is greater than X2.

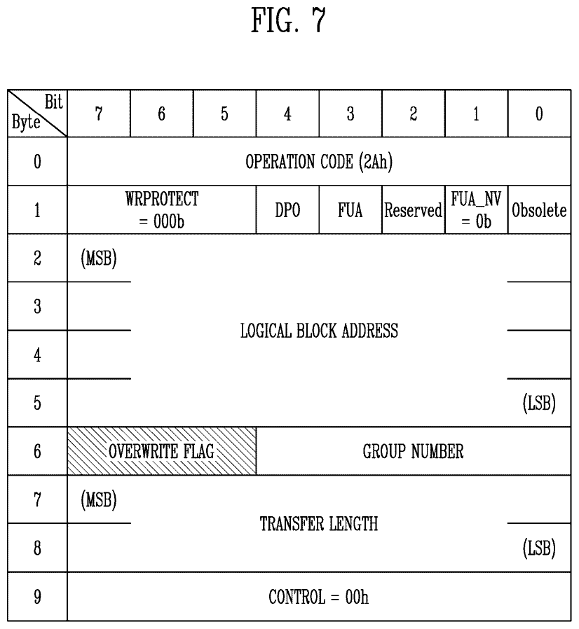

FIG. 7 is a diagram for explaining information included in a write request based on some implementations of the disclosed technology.

FIG. 7 shows the example structure of a write request defined in universal flash storage (UFS) specification.

The write request may include fields (components) for operation code, write protection (WRPROTECT), Disable Page Out (DPO), a Force Unit Access (FUA), logical block address, a group number, an overwrite flag, transfer length, and a control signal.

The components constituting the write request may be variously changed based on the communication scheme with the host 400, which is described above with reference to FIG. 1.

In an embodiment, the write request may include an overwrite flag.

The overwrite flag may have a value of 0 or 1. In various embodiments, although the overwrite flag may have 2 or more bits, the embodiment of the present disclosure is not intended to limit the number of bits in the overwrite flag.

The overwrite flag may indicate whether the corresponding write request is an overwrite request indicative of the update for a pre-stored logical address. The case where the overwrite flag is 1 may indicate that the write request is the overwrite request, and the case where the overwrite flag is 0 may indicate that the write request is not an overwrite request.

With the overwrite flag, the map update manager 240, which is described above with reference to FIG. 4, may be able to know in advance whether an invalidation operation is to be performed on old map data during a write map cache flush operation. When the write request is the overwrite request, the invalidation processing on old map data that is a previously stored logical address needs to be additionally performed. When the write request includes the overwrite flag, the map data manager 240 may selectively perform the invalidation processing on the old map data when performing a write map cache flush operation.

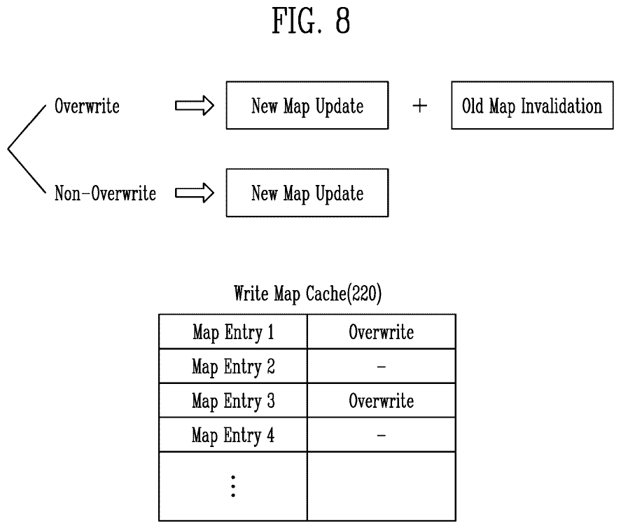

FIG. 8 is a diagram for explaining the difference between map update methods depending on whether a write request is an overwrite request based on some implementations of the disclosed technology.

Referring to FIG. 8, when the write request is an overwrite request indicative of the update for a pre-stored logical address, old map data that is a map entry corresponding to the pre-stored logical address may be stored in the memory device. Therefore, when the update for new map data including a physical address corresponding to the logical address of newly received write data is performed, an invalidation operation on the old map data needs to be additionally performed. When the write request is not an overwrite request, an invalidation operation on the old map data is not required, and thus the update only for new map data may be performed.

In the case where the write request includes the overwrite flag, the write map cache 220, which is described above with reference to FIG. 4, may store information about whether each map entry corresponds to the write request that is an overwrite request, together with the map entry, when storing the corresponding map entry. By means of this process, the map data manager 240 may selectively perform an invalidation operation on old map data during the write map cache flush operation.

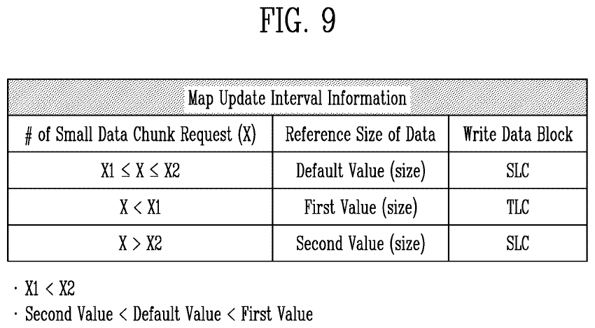

FIG. 9 is a diagram illustrating an embodiment of map update interval information based on some implementations of the disclosed technology.

Referring to FIG. 9, the map update interval information may further include information about a write data block indicating a block in which write data is to be stored.

The map data manager 240, which is described with reference to FIG. 4, may perform a write map cache flush operation based on a reference size having a default value when the number of small data chunk write requests included in write requests received from the host until the accumulated size of the write data reaches the reference size is equal to or greater than X1 and less than or equal to X2 (where X2 is greater than X1).

In some implementations, the map data manager 240 may perform the write map cache flush operation based on the reference size having a second value less than the default value when the number of small data chunk write requests included in the write requests received from the host until the accumulated size of the write data reaches the reference size is greater than X2.

When the reference size is the default value or the second value less than the default value, the number of map entries that are the target of the write map cache flush operation may be relatively small, and the time required to perform the write map cache flush operation may be relatively short. In this case, the operation controller 210 may program write data in an SLC manner when storing write data, stored in the write data buffer 230, in the memory device 100.

The map data manager 240 may perform the write map cache flush operation based on the reference size having a first value greater than the default value when the number of small data chunk write requests included in the write requests received from the host until the accumulated size of the write data reaches the reference size is less than X1. In this case, the number of map entries that are the target of the write map cache flush operation may be relatively large, and the time required to perform the write map cache flush operation may be relatively long. Therefore, the operation controller 210 may program write data in a TLC manner having a program time longer than that in the SLC manner when storing the write data, stored in the write data buffer 230, in the memory device 100.

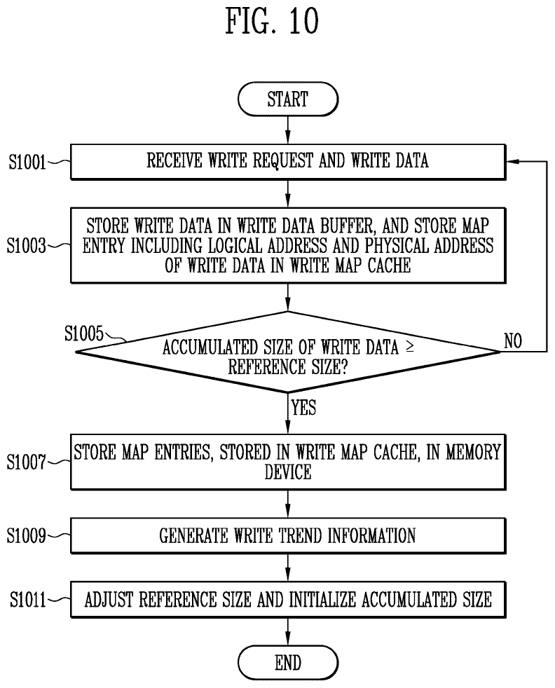

FIG. 10 is a flowchart illustrating the operation of a data storage device according to an embodiment of the present disclosure.

Referring to FIG. 10, at step S1001, the data storage device may receive a write request and write data from a host. The write request may include a logical address for identifying the write data. In various embodiments, the write request may include an overwrite flag indicating whether the write request is an overwrite request indicative of the update for a pre-stored logical address.

At step S1003, the data storage device may store the write data in a write data buffer, and may store a map entry including the logical address and the physical address of the write data in a write map cache.

At step S1005, the data storage device may determine whether the accumulated size of the write data is equal to or greater than a reference size. As a result of the determination, when the accumulated size of the write data is equal to or greater than the reference size, the process may proceed to step S1007, otherwise the process may repeatedly perform steps S1001 and S1003.

At step S1007, the data storage device may store map entries, stored in the write map cache, in the memory device.

At step S1009, the data storage device may generate write tend information indicating the number of small data chunk write requests among write requests that are received until the accumulated size of the write data becomes equal to or greater than the reference size.

At step S1011, the data storage device may adjust the reference size based on the write trend information. For example, when the number of small data chunk write requests among the write requests, received until the accumulated size of the write data becomes equal to or greater than the reference size, is less than a first reference number, the reference size may be changed to a first value greater than a preset default value. Also, when the number of small data chunk write requests is greater than a second reference number, the reference size may be changed to a second value less than the preset default value. The data storage device may initialize the accumulated size after adjusting the reference size.

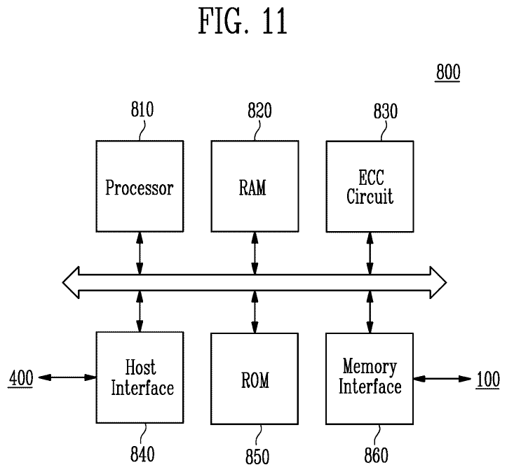

FIG. 11 is a diagram illustrating an embodiment of the controller of FIG. 1.

Referring to FIG. 11, a memory controller 800 may include a processor 810, a random access memory (RAM) 820, an error correction circuit 830, a host interface 840, a read only memory (ROM) 850, and a memory interface 860. The memory controller 800 may be the controller 200, described above with reference to FIG. 1.

The processor 810 may control the overall operation of the memory controller 800. The RAM 820 may be used as a buffer memory, a cache memory or a working memory of the memory controller 800. An operation controller 210 and a map data manager 240, described above with reference to FIG. 4, may be stored in the ROM 850 or the RAM 820 in the form of software executed by the processor 810. Further, a write map cache 220, a write data buffer 230, and a trend information storage 250 may be included in the RAM 820.

In an embodiment, the ROM 850 may store various types of information required for operating the memory controller 800 in the form of firmware.

The memory controller 800 may communicate with an external device (e.g., the host 400, an application processor or the like) through the host interface 840.

The memory controller 800 may communicate with the memory device 100 through the memory interface 860. The memory controller 800 may transmit a command CMD, an address ADDR, a control signal CTRL, or the like to the memory device 100 and receive data DATA from the memory device 100, through the memory interface 860.

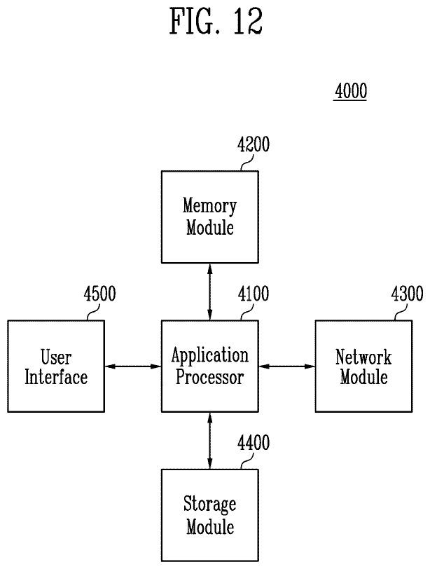

FIG. 12 is a block diagram illustrating a user system to which a data storage device according to an embodiment of the present disclosure is applied.

Referring to FIG. 12, a user system 4000 may include an application processor 4100, a memory module 4200, a network module 4300, a storage module 4400, and a user interface 4500.

The application processor 4100 may run components included in the user system 4000, an operating system (OS) or a user program. In an embodiment, the application processor 4100 may include controllers, interfaces, graphic engines, etc. for controlling the components included in the user system 4000. The application processor 4100 may be provided as a system-on-chip (SoC).

The memory module 4200 may function as a main memory, a working memory, a buffer memory or a cache memory of the user system 4000. The memory module 4200 may include volatile RAMs such as DRAM, SDRAM, DDR SDRAM, DDR2 SDRAM, DDR3 SDRAM, LPDDR SDRAM, LPDDR2 SDRAM, and/or LPDDR3 SDRAM or nonvolatile RAMs such as PCM, ReRAM, MRAM, and/or FRAM. In an embodiment, the application processor 4100 and the memory module 4200 may be packaged based on a package-on-package (POP), and may then be provided as a single semiconductor package.

The network module 4300 may communicate with external devices. In an embodiment, the network module 4300 may support a wireless communication, such as code division multiple access (CDMA), a global system for mobile communication (GSM), wideband CDMA (WCDMA), CDMA-2000, time division multiple access (TDMA), long term evolution (LTE), Wimax, WLAN, UWB, Bluetooth, or Wi-Fi. In an embodiment, the network module 4300 may be included in the application processor 4100.

The storage module 4400 may store data. For example, the storage module 4400 may store data received from the application processor 4100. Alternatively, the storage module 4400 may transmit the data stored in the storage module 4400 to the application processor 4100. In an embodiment, the storage module 4400 may be implemented as a nonvolatile semiconductor memory device, such as a phase-change RAM (PRAM), a magnetic RAM (MRAM), a resistive RAM (RRAM), a NAND flash memory, a NOR flash memory, or a NAND flash memory having a three-dimensional (3D) structure. In an embodiment, the storage module 4400 may be the data storage device 50, described above with reference to FIG. 1. Alternatively, in various embodiments, the storage module 4400 may be provided as a removable storage medium (removable drive), such as a memory card or an external drive of the user system 4000.

In an embodiment, the storage module 4400 may include a plurality of nonvolatile memory devices, each of which may be operated in the same manner as the memory device 100, described above with reference to FIG. 1. The storage module 4400 may be operated in the same manner as the data storage device 50, described above with reference to FIG. 1.

The user interface 4500 may include interfaces which input data or instructions to the application processor 4100 or output data to external devices. In an embodiment, the user interface 4500 may include user input interfaces such as a keyboard, a keypad, a button, a touch panel, a touch screen, a touch pad, a touch ball, a camera, a microphone, a gyroscope sensor, a vibration sensor, and a piezoelectric element. The user interface 4500 may include user output interfaces such as a liquid crystal display (LCD), an organic light emitting diode (OLED) display device, an active matrix OLED (AMOLED) display device, an LED, a speaker, and a monitor.

The present disclosure may provide a data storage device for dynamically managing a map update cycle and a method of operating the data storage device.

Only a few implementations and examples are described and other implementations, enhancements and variations can be made based on what is described and illustrated in this patent document.

What is claimed is:

1. A controller for controlling a memory device, comprising:
a write data buffer configured to temporarily store write data that is provided from a host;
a write map cache configured to store a map entry including a logical address corresponding to the write data and a physical address that corresponds to the logical address and indicates a location at which the write data is to be stored in the memory device; and
a map data manager configured to store, in the memory device, the map entry that has been stored in the write map cache in response to an accumulated size of the write data accumulated in the write data buffer reaches a reference size, generate write trend information indicating a number of small data chunk write requests among write requests that have been received from the host until the size of the write data accumulated in the write data buffer reaches the reference size, the small data chunk write requests including write requests for data having a preset unit size, and adjust the reference size based on the write trend information.

2. The controller according to claim 1, wherein the map data manager is configured to decrease the reference size as the number of small data chunk write requests increases.

3. The controller according to claim 1, wherein the map data manager is configured to change the reference size to a first value greater than a preset default value when the number of small data chunk write requests, among the write requests that have been received from the host until the accumulated size of the write data reaches the reference size, is less than a first reference number.

4. The controller according to claim 3, further comprising:
an operation controller configured to control the memory device so that at least 2 bits of the write data are stored in each of memory cells included in the memory device when the reference size is the first value.

5. The controller according to claim 1, wherein the map data manager is configured to change the reference size to a second value less than a preset default value when the number of small data chunk write requests, among the write requests that have been received from the host until the accumulated size of the write data reaches the reference size, is greater than a second reference number.

6. The controller according to claim 1, wherein the map data manager is configured to adjust the reference size based on the write trend information and initialize the accumulated size of the write data accumulated in the write data buffer after adjusting the reference size.

7. The controller according to claim 1, further comprising:
a trend information storage configured to store the write trend information,
wherein the trend information storage further stores map update interval information about a value of the reference size based on the number of small data chunk write requests.

8. The controller according to claim 1, wherein the preset unit size is less than or equal to 4 KB.

9. The controller according to claim 1, further comprising:
an operation controller configured to receive a write request and write data corresponding to the write request from the host, and control the memory device to perform a write data flush operation of storing the write data in the memory device in response to the accumulated size of the write data accumulated in the write data buffer reaches the reference size.

10. The controller according to claim 1, wherein:
each of the write requests includes an overwrite flag that indicates whether a corresponding write request is an overwrite request indicating an update for the logical address corresponding to temporarily stored write data, and
the map data manager is configured to selectively perform an invalidation operation on a logical address corresponding to the overwrite request based on the overwrite flag.

11. A controller, comprising:
a host interface configured to receive a write request and write data from a host;
a volatile memory device including a write data buffer configured to temporarily store the write data and a write map cache configured to store a map entry including a logical address corresponding to the write data and a physical address indicating a location at which the write data is to be stored to correspond to the logical address;
a memory interface configured to communicate with a memory device; and
a processor configured to control the host interface, the volatile memory device, and the memory interface,
wherein the processor is configured to control the memory interface to store the map entry stored in the write map cache in the memory device in response to an accumulated size of the write data received from the host reaches a reference size, to generate write trend information indicating a number of small data chunk write requests that correspond to write requests for data having a preset unit size, among write requests that have been received from the host until the accumulated size of the write data reaches the reference size, and to adjust the reference size based on the write trend information.

12. The controller according to claim 11, wherein the preset unit size is less than or equal to 4 KB.

13. The controller according to claim 11, wherein the volatile memory device is a static random access memory.

14. The controller according to claim 11, wherein the volatile memory device is configured to store the write trend information and map update interval information about a value of the reference size based on the number of small data chunk write requests.

15. The controller according to claim 11, wherein the processor is configured to decrease the reference size as the number of small data chunk write requests increases.

16. The controller according to claim 11, wherein the processor is configured to change the reference size to a first value greater than a preset default value when the number of small data chunk write requests, among the write requests received from the host until the accumulated size of the write data reaches the reference size, is less than a first reference number.

17. The controller according to claim 11, wherein the processor is configured to change the reference size to a second value less than a preset default value when the number of small data chunk write requests, among the write requests received from the host until the accumulated size of the write data reaches the reference size, is greater than a second reference number.

18. A data storage device, comprising:
a memory device configured to store data; and
a controller configured to adjust a cycle at which map data corresponding to write requests received from a host for a preset reference time is stored in the memory device, based on a number of small data chunk write requests to write data having a preset unit size.

19. The data storage device according to claim 18, wherein the controller is configured to increase the cycle as the number of small data chunk write requests decreases.
